(19) United States
(12) Patent Application Publication
(10) Pub. No.: US 2023/0124577 A1
(43) Pub. Date: Apr. 20, 2023

(54) AUTOMATED EXCHANGE FOR SERVICES USING SERVICE TIME UNITS

(71) Applicant: Sergey Kheyfets, Brooklyn, NY (US)

(72) Inventor: Sergey Kheyfets, Brooklyn, NY (US)

(21) Appl. No.: 18/074,256

(22) Filed: Dec. 2, 2022

Related U.S. Application Data
(63) Continuation-in-part of application No. 17/965,468, filed on Oct. 13, 2022.
(60) Provisional application No. 63/256,355, filed on Oct. 15, 2021.

(51) Int. Cl. G06Q 40/12

(52) U.S. Cl. CPC G06Q 40/125

(57) ABSTRACT

A system is provided that includes a server computer coupled to a plurality of client devices over a communication network, the server computer configured at least to: receive a plurality of orders for a service from the plurality of client devices, the plurality of orders include an order to purchase the service having a price and a size, and an order so sell the service having a price and a size, wherein the size of the purchase order and the sell order is stated in time units and wherein the price of the purchase order and the sell order is stated in time units; maintain a dynamic trade book comprising the plurality of orders sorted based on best price; match purchase orders and the sell orders; automatically execute matching purchase orders and the sell orders; and update account records to reflect executed purchase orders and the sell orders.

### RELATED APPLICATIONS

This application is a continuation-in-part of U.S. application Ser. No. 17/965,468, filed on Oct. 13, 2022, entitled “AUTOMATED EXCHANGE FOR SERVICES USING SERVICE TIME UNITS” which claims priority to U.S. Provisional Application No. 63/256,355, filed on Oct. 15, 2021, entitled “METHOD OF OFFERING LONG TERM CARE USING SERVICE TIME UNITS” which are hereby incorporated by reference in their entirety.

### BACKGROUND OF THE INVENTION

The present application relates to automated exchanges, and more particularly, automated exchanges for such goods and/or services.

Automated computer exchanges, for example, for products, such as securities, goods, services, etc., are known. In these types of systems, the owner or interested party offers a product in exchange for money. For example, seller A may offer to sell a commodity ABC for 100 USD at that time T1. If the seller and buyer have access to the same information regarding ABC, the parties can reasonably assess the risk associated with the transaction (i.e., overpaying or underpaying). Transactions in which the time for delivery is for a much later date, for example, years in the future, present a greater uncertainty. Various vehicles have been created to minimize risk, such as options, futures, etc., but automated exchanges for these types of vehicles do not work well with respect to the exchange of complex services, such as long term care. Accordingly, there is a need for automated exchanges with improved interfaces for such services that are not so limited.

### SUMMARY OF THE INVENTION

In one aspect, system is provided that includes a server computer coupled to a plurality of client devices over a communication network, the server computer configured at least to: receive a plurality of orders for a service from the plurality of client devices, the plurality of orders comprising an order to purchase the service having a price and a size, and an order so sell the service having a price and a size, wherein the size of the purchase order and the sell order is stated in time units and wherein the price of the purchase order and the sell order is stated in time units; maintain a dynamic trade book comprising the plurality of orders sorted based on best price; match purchase orders and the sell orders; automatically execute matching purchase orders and the sell orders; and update account records to reflect executed purchase orders and the sell orders.

In one embodiment, the service comprises long term care services.

In one embodiment, the server is further configured to cause an interface screen to be displayed at client devices, the interface screen comprising form elements for users to enter purchase order and the sell order details.

In one embodiment, the server is further configured to cause an interface screen to be displayed at client devices, the interface screen comprising a representation of the trade book in a tabular form.

In one embodiment, the server is further configured to cause an interface screen to be displayed at client devices, the interface screen comprising a form element for a service provider to set aside hour units for exchange against purchase orders.

In one embodiment, the server is further configured to interface with a payroll management system and update account records to reflect service units earned for a predetermined period of time.

In one embodiment, the server is further configured to cause an interface screen to be displayed at client devices, the interface screen comprising form elements for users to enter purchase order and the sell order details, wherein the purchase order details comprises at least price, size, and duration of the order.

In another aspect, a method implemented in a system is provided that includes a server computer coupled to a plurality of client devices over a communication network, the method includes: receiving, by the server computer, a plurality of orders for a service from the plurality of client devices, the plurality of orders comprising an order to purchase the service having a price and a size, and an order so sell the service having a price and a size, wherein the size of the purchase order and the sell order is stated in time units and wherein the price of the purchase order and the sell order is stated in time units; maintaining, by the server computer, a dynamic trade book comprising the plurality of orders sorted based on best price; matching, by the server computer, purchase orders and the sell orders; automatically executing, by the server computer, matching purchase orders and the sell orders; and updating, by the server computer, account records to reflect executed purchase orders and the sell orders.

In one embodiment, the service comprises long term care services.

In one embodiment, the method includes causing, by the server, an interface screen to be displayed at client devices, the interface screen comprising form elements for users to enter purchase order and the sell order details.

In one embodiment, the method includes causing, by the server, an interface screen to be displayed at client devices, the interface screen comprising a representation of the trade book in a tabular form.

In one embodiment, the method includes causing, by the server, an interface screen to be displayed at client devices, the interface screen comprising a form element for a service provider to set aside hour units for exchange against purchase orders.

In one embodiment, the method includes interfacing, by the server, with a payroll management system and updating account records to reflect service units earned for a predetermined period of time.

In one embodiment, the method includes causing, by the server, an interface screen to be displayed at client devices, the interface screen comprising form elements for users to enter purchase order and the sell order details, wherein the purchase order details comprises at least price, size, and duration of the order.

In one embodiment, the system is configured to display a plurality of interface screens based on access permissions from a plurality of access permissions comprising customer, provider, and trader access permissions, the plurality of interface screen comprising a customer interface screen, a provider interface screen, and a trader interface screen, wherein the plurality of interface screens include therein form elements accessible only by a given user based on the access permission.

In one embodiment, the customer interface screen comprises a listing of a plurality of available sell orders stated in time units, each of the sell orders including a bid price form element and an ask price form element, and wherein the customer interface screen allows the given user to enter a price in the bid price form element and not the ask price form element.

In one embodiment, the provider interface screen comprises a listing of a plurality of available buy orders stated in time units, each of the buy orders including a bid price form element and an ask price form element, and wherein the provider interface screen allows the given user to enter a price in the ask price form element and not the bid price form element.

In one embodiment, the trader interface screen comprises a listing of a plurality of available buy and sell orders stated in time units, each of the buy and sell orders including a bid price form element and an ask price form element, and wherein the trader interface screen allows the given user to enter a price in the bid price form element and the ask price form element.

In one embodiment, the trader interface screen allows the given user to enter price information in a plurality of the bid price form element and ask price form elements, and wherein the system automatically executes orders at a best price for each of the price information entered by the user that is better than the displayed prices.

Additional aspects of the present invention will be apparent in view of the description which follows.

### BRIEF DESCRIPTION OF THE FIGURES

FIG. 1 is a system diagram for an automated exchange according to at least one embodiment of the systems disclosed herein.

FIG. 2 is a flow diagram for a method in an automated exchange according to at least one embodiment of the method disclosed herein.

FIGS. 3-5 are graphic user interface screens generated by an automated exchange according to at least one embodiment of the system disclosed herein.

### DETAILED DESCRIPTION OF THE INVENTION

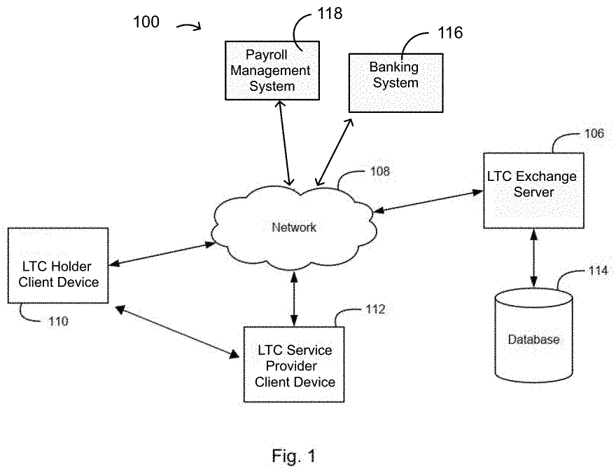

FIG. 1 illustrates an exemplary computing system configured to provide the functionality disclosed herein. The system presented in FIG. 1 may include one or more LTC exchange server(s) 106 coupled to one or more databases 114, a communication network 108, and/or a client device 110, 112, or any combination thereof.

LTC exchange server(s) 106, as described herein, may vary widely in configuration or capabilities, but are preferably special-purpose digital computing devices that include at least one or more central processing units and computer memory. The server(s) 106 may also include one or more of mass storage devices, power supplies, wired or wireless network interfaces, input/output interfaces, and operating systems, such as Windows Server, Mac OS X, Unix, Linux, FreeBSD, or the like. In an example embodiment, server(s) 106 may include or have access to memory for storing instructions or applications for the performance of various functions and a corresponding processor for executing the stored instructions or applications. For example, the memory may store an instance of the server(s) 106 configured to operate in accordance with the embodiments disclosed herein.

According to another embodiment, server(s) 106 may include cloud computing data centers configured to provide client devices 110, 112 with access to an application, service, or platform. For example, Software-as-a-Service (“SaaS”) provides the capability to use a provider's applications running on a cloud infrastructure. The applications in these instances may be accessible from various client devices 112 through a thin client interface, such as a web browser or an application or app. Cloud computing includes a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Server(s) 106 may connect to the client devices 110, 112 directly or through a communication interface. The server(s) 106 generally store the information captured, or otherwise supplied or uploaded thereto from one or more of the system components, including client devices 110, 112, including LTC hour-unit holder account information and LTC service unit provider account information, as discussed below. The server(s) may provide a platform that includes a web interface that can be accessed over network 108 to view webpages that present and/or display and obtain information therefrom with respect to, inter alia, the long term care units discussed herein. The exchange servers 106 may be operated by one or more service providers. For instance, a first service provider may operate one or more servers and provide access to a repository of long term care and related information for use by the system 100. The server(s) 106 preferably includes a matching engine that automatically matches buyers and sellers of LTC units, and/or offers and bids for LTC units, including long term care service units, as discussed below.

Communication network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from devices may be encrypted using, for example, the Advanced Encryption Standard (AES) with a 128, 192, or 256-bit key size, or any other encryption standard known in the art.

Client devices 110, 112 may include computing devices (e.g., desktop computers, laptops, personal digital assistants (PDA), cellular phones, smartphones, tablet computers, or any computing device having a central processing unit and memory unit capable of connecting to a network). The client device 110, 112 may include computing devices and vary in terms of capabilities or features, for example, a cell/smart phone, a tablet computer, a laptop, an in-dash car computer, or the like. The client device 110, 112 may include a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display.

In one aspect, the system(s) discussed above provide an automated exchange for Long Term Care (LTC) units, specifically Home Care Services. LTC is a difficult service to provide via an automated exchange and therefore difficult for buyers and service providers to hedge their respective risks. Accordingly, at least one objective of the present application is to provide a computer system for efficiently and automatically exchanging such complex service units that beneficially results in adequate care to eligible recipients at costs reasonable for the service providers, federal, and state government budgets, and the recipients themselves, as a result of the improved efficiency. With each passing year, expenses and logistical hurdles associated with providing long term care rise for various subjective and objective reasons, e.g., inflation, minimum wage increases, increase of average life longevity, and the like. Accordingly, there is a growing need in LTC systems, which will be available for all eligible recipients while maintaining the costs of such care at reasonable level and enticing providers, local, State, and Federal governments, and financial institutions to participate in and support the LTC system. These tangible benefits are the results of improvements in the operation of the automated exchanges discussed herein.

Continuing to use the current method of offering and providing LTC becomes less sustainable as the inflation and costs of services will soon render the cost of LTC to be inaccessible to most eligible recipients and government budgets would not be able to subsidize the required care. The present application therefore provides automated exchanges that enable future and existing eligible recipients of LTC to purchase LTC hour-units and/or LTC service units from various authorized entities, e.g., insurance companies, MLTC providers, stock market, financial institutions, individuals, employers, etc. that would assure the existing and potential eligible recipients of LTC of guaranteed continuous availability of LTC benefits, notwithstanding the ever-rising costs of LTC.

More specifically, the invention described in this application includes one or more of the following elements/features:

Implementation of the proposed novel system will enable future and existing participants to allocate necessary budget in advance and purchase LTC hour-units, generally LTC purchase units, well in advance of the time when LTC is needed. Specifically, LTC hour-units may be purchased by a purchaser during a predetermined accumulation period, LTC hour-units to be used for LTC service units redeemable by an insurance company through a bargaining process during which several insurance companies may compete for a right to receive LTC purchase units in exchange for LTC service units.

According to a preferred embodiment of the invention disclosed herein, a number of LTC hour-units available for a purchase may not be restricted and purchasers can use the purchased LTC hour-units as a commodity, to sell it on an exchange, gift it to any third party, sell back to the sellers, bequeath it to any third party, use it as collateral, or exchange for a different type of services or goods.

By way of sample: a senior citizen of 75 years of age (“Patient”) is in need of LTC service. According to general estimation, during the first 5 years of LTC care, the Patient may require 20-24 hours/week (1,040-1,248 hours/year) of LTC services, after the initial 5 years of LTC service and for the next 5 years, the Patient may require 36-40 hours/week (1,872-2,080 hours/year) of LTC service. After initial 10 years of LTC service, the Patient may require 80-168 hours/week (4,160-8,736 hours/year) of LTC service. Given the current estimated life expectancy for senior citizens in the US to be 90-95 years, the total approximate amount of hours of LTC service could be calculated as 5×20 (24)+5×36 (40)+5 (10)×80 (168)=5,200 (6,240)+9,360 (10,400)+20,800 (43,600) [41,600 (87,360)]=35,360 (60,240) [56,160 (104,000)].

This example illustrates a common approach for calculating the maximum amount of the service hours. It is to be understood that methods of calculation of the approximated required number of LTC hour-units may vary depending on other variables.

Ability to purchase and accumulate LTC hour-units will enable the Patient to choose from several MLTC providers and negotiate the extent of the service sought from LTC provider, when necessary.

The novel method disclosed herein is also beneficial for life insurance companies as these companies could generate additional revenues by participating in the market exchange of LTC hour-units.

Since the disclosed method may be set in the manner which enables a holder of LTC hour-units to solicit competing bids from various LTC providers, such practice may result in an eligible recipient of LTC receiving more services for recipient's LTC hour-unit.

Being able to use LTC hour-units as currency/commodity may enable holders of LTC hour-units to manage a portfolio of LTC hour-units without any interference or involvement of any third parties, e.g., doctors, insurers, or LTC providers. Eligible participants will be able to manage their LTC hour-unit reserves by independently determining the number of hours they need and adjusting their care depending on their need at various periods of time and circumstances.

Eligible participants may freely trade LTC hour-units or even give it to other parties as a gift or in exchange for other services or goods. Eligible participants may bequeath LTC hour-units to their family members.

Additional benefit of the proposed method is in medical and life insurance providers being able to use traditional mechanisms (bonds, debentures, indexes, etc.) for hedging their future payments while using the novel LTC hour-units, thereby creating an additional marketplace, and generating additional substantial revenues for eligible LTC recipients, LTC providers, insurance companies, financial exchanges, financial institutions.

Employers of future eligible participants may elect to invest in LTC hour-units for its employees instead of investing in pension plans that will be substantially devalued by the time employees become eligible for the pension.

Additional benefit of the proposed method is in enabling the stock market to generate additional revenues by trading LTC hour-units as commodity, creating new tradable stock or financial indices.

Adoption of the novel proposed method will cause the growth of jobs within the existing LTC system and within any industry that will engage in trading and/or processing LTC hour-units. Also, the novel proposed method will ensure coordination among LTC insurance companies, life insurance companies, financial institutions, which, in turn, will generate additional financial influx in the healthcare system.

Adoption of the novel proposed method and its influence on financial markets will help reduce the need for subsidies from local, State, and Federal and local government expenses for the healthcare system, thereby alleviating a financial strain on government budgets.

A person skilled in the art will understand that the proposed LTC hour-units may be expanded to all other areas of healthcare, such as urgent care, out-patient care, in-patient care, preventive care, specialty care, disability benefits, and the like.

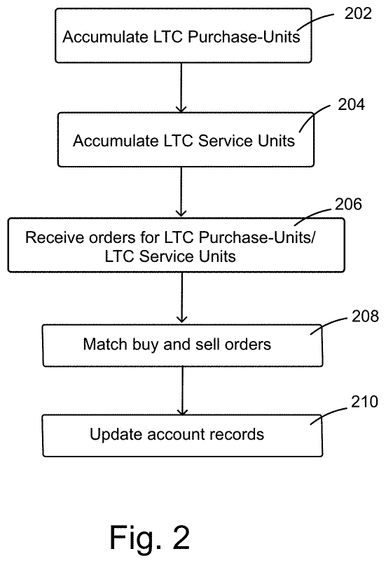

FIG. 2 illustrates an exemplary computer implemented method in an automated electronic exchange of LTC units, as discussed herein. In one embodiment, the method may begin with an accumulation of LTC hour-units, generally LTC purchase units, step or steps 202. Accumulation may be achieved in a variety of ways. Preferably, accumulation begins with a user acquiring LTC hour-units.

For example, LTC hour-units may be granted to an employee as a function of hour worked. For example, one LTC hour-unit may be earned automatically for every 40 hours worked by the employee. In this regard, the system 100 may interface with a payroll management system 118, such as via an API, for example, by sending a call that passes employee ID information to the payroll management system 118 and receives in response thereto information, such as hours worked by the given employee, to compute LTC hour-units earned for the period. The system 100 may then add LTC hour-units earned by the employee for the given period to the total LTC hour-units held by the employee.

Alternatively or additionally, the employee/system user may purchase LTC hour-units from a provider or from another system user. The employer and/or employee may purchase LTC hour-units and the system may deduct the cost associated with the purchase from the employee's and/or employer's account, such as checking, savings, etc. In this instance, the system 100 may interface with payroll management system, the provider system, and/or banking system, to automatically purchase or purchase on demand LTC hour-units, which are then added to the user account. In this regard, the system 100 provides users with access to account information, including LTC hour-units held by the given user.

In one embodiment, the system 100 provides an automated exchange of LTC hour-units for a service, for example, from a service provider, such as an LTC service provider. In this regard, the system 100 preferably provides service providers with accounts, which track LTC service units held by the service provider or other user. For example, a service provider may set aside 1000 service hours for exchange with LTC hour-unit holders. In this regard, the method includes accumulating LTC service units for at least one service provider at 204.

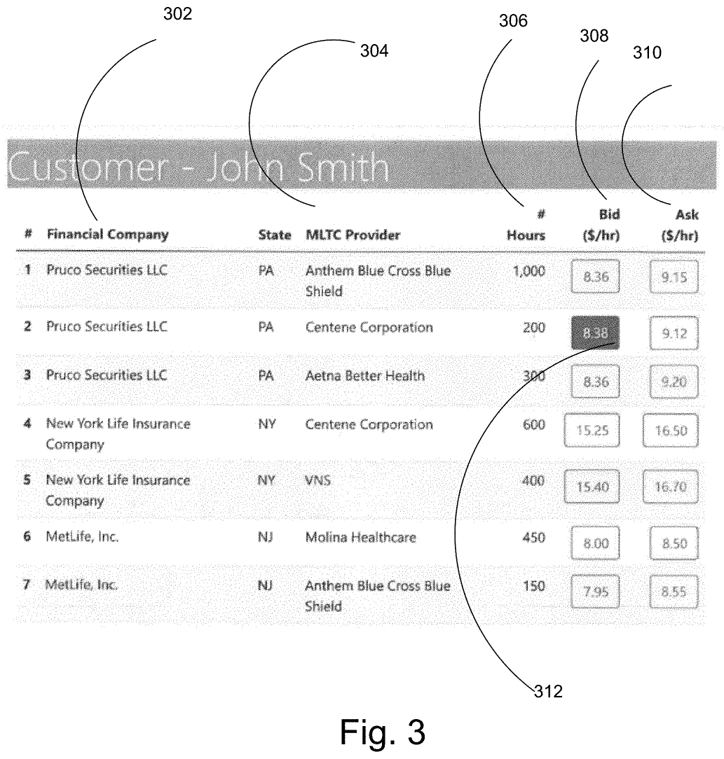

In one embodiment, the system 100 allows users, including LTC hour-unit holders and LTC service providers, to place electronic orders for LTC services units and LTC purchase units, respectively. For example, the system 100 may cause an interface screen to be displayed with form elements therein for the user to enter order details, such as whether the order is a buy or sell, and the terms of the order, including price (express or market price), size, duration of the order (day, etc.), etc. The price and size of the orders are preferably stated in time units, such as hours. For example, the LTC hour-unit holder may specify the desire to purchase 10 LTC service hours and the price 9 LTC hour-units. Similarly, the service provider may offer to sell 10 service hour units in exchange for 9.5 LTC purchase hour-units. Exemplary interface screens are shown in FIGS. 3-5 hereto.

Therefore, at step 206, the system 100 receives a plurality of orders for LTC Hour-Units/LTC Service Hour Units from a plurality of system users and maintains an electronic trade book, which includes the buy and sell orders sorted based on the price. That is, the system maintains a dynamic list of buy orders sorted by best (high) to low and a list of sell orders sorted from best (low) to high, displayed to traders on a graphic user interface with the orders selectable by users for automated execution. The lists are preferably displayed in a tabular layout with the best buy and sell orders on the same row, with the lists dynamically updated in real time as orders enter and/or are executed. When the buy and sell orders cross, i.e., the price to buy is higher than the price to sell, the system preferably matches crossing orders and executes orders automatically at 208, preferably at an average of the buy and sell prices. The system then updates the parties' accounts to reflect order execution. The system may further include a market maker computer that automatically imparts liquidity in the system.

In at least one embodiment, the system generates a customer interface screen, as shown in FIG. 3. The customer interface is generated by the system based on access permissions associated with a given user from a plurality of access permissions, each providing different levels of access based on classification of the user as a customer, trader, or provider. With respect to customers, the interface screen may include a listing of the available LTC offers to buy/sell service hours from a plurality of providers. Preferably, the LTC offer listing includes relevant information, such as financial company name 302, state, LTC Provider name 304, number of hours available 306, bid information 308, and ask information 310. Preferably, the list is sorted in the customer interface based on ask price, i.e., lowest to highest. Preferably, the bid and/or ask information form elements update in real-time as orders (bids/asks) are entered into the system, pushed to the customer for dynamic pricing. In one embodiment, the customer is able to enter a bid price into the listing interface, which causes the selected bid form element 312 to highlight its selection. The user may then place a bid price that is better than the displayed bid price. This will cause the customers better bid to replace the previously best bid price in the queue for the given LTC offer. The user may enter a price that is the same or better than the displayed ask price, which will cause the order to be executed at the displayed ask price. Alternatively, the customer may simply select or “take” the asking price to automatically execute the order at the ask price. In this interface, the customer is not able to enter information except on the authorized form elements, that is, the bid price.

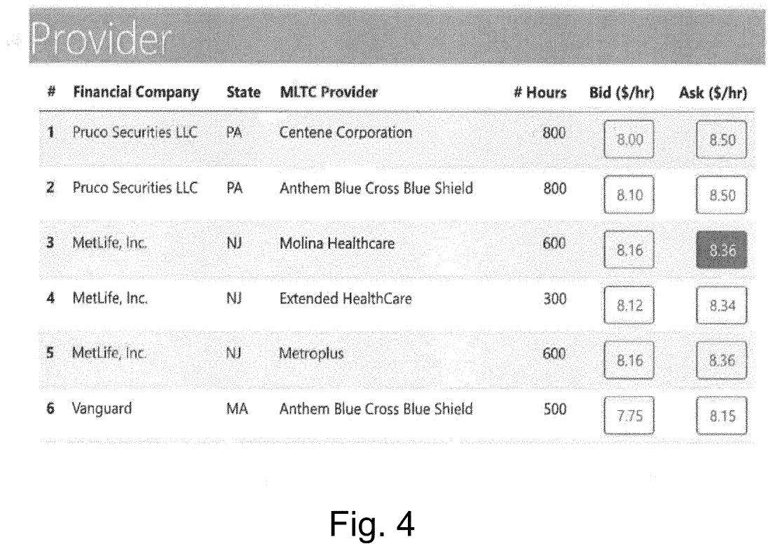

In at least one embodiment, the system generates a provider interface screen, as shown in FIG. 4. The provider interface is generated by the system based on access permissions associated with a given user from a plurality of access permissions, each providing different levels of access based on classification of the user as a customer, trader, or provider, as discussed above. With respect to providers, the interface screen similarly includes a listing of the available LTC offers to buy/sell service hours from a plurality of providers, similar to the customer interface. Preferably, the list is sorted in this interface based on bid price, i.e., highest to lowest. Preferably, the bid and/or ask information form elements update in real-time as orders (bids/asks) are entered into the system, pushed to the provider for dynamic pricing. In one embodiment, the provider is able to enter a bid price into the listing interface, but only for the order for which the provider is listed as an MLTC provider, as shown. The other ask form elements will not be editable in the given provider's LTC listing. Selection of the provider's ask price causes the ask form element to be highlighted in response to its selection. The provider may then place an ask price that is better than the displayed ask price. This will cause the providers better to replace the previously best ask price in the queue for the given LTC offer. The user may enter a price that is the same or better than the displayed bid price, which will cause the order to be executed at the displayed price. Alternatively, the provider may simply select or “take” the bidding price to automatically execute the order for the provider's order at the bid price. In this interface, the provider is not able to enter information except on the authorized form elements, that is, provider's own ask price.

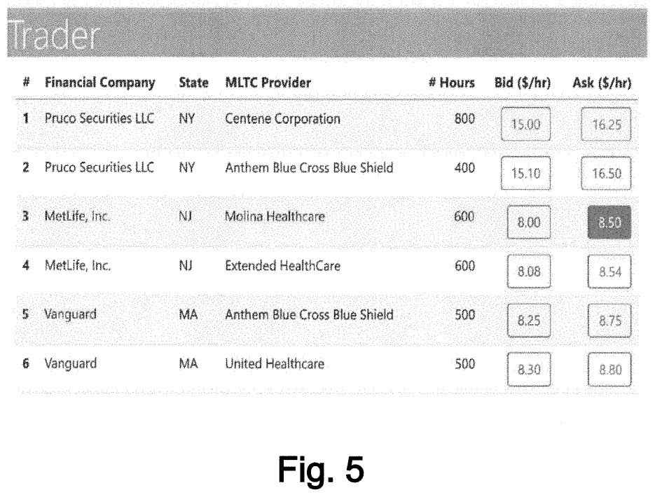

In at least one embodiment, the system generates a trader interface screen, as shown in FIG. 5. The trader interface is generated by the system similarly based on access permissions associated with a given user from a plurality of access permissions. With respect to traders, the interface screen similarly includes a listing of the available LTC offers to buy/sell service hours from a plurality of providers. Preferably, the list is sorted in this interface based on either bid or ask price, i.e., highest to lowest. Preferably, the bid and/or ask information form elements update in real-time as orders (bids/asks) are entered into the system, pushed to the trader for dynamic pricing.

In one embodiment, the trader is able to enter a bid or ask price into the listing interface in any of the offers displayed on the LTC listing. Selection of the bid or ask price causes the bid/ask form element to be highlighted in response to its selection. The trader may then place a price that is better than the displayed bid or ask price. Preferably, the trader will be allowed to enter bid and/or ask prices in a plurality of the displayed listings at a given time. This will cause the trader's better bid/ask to replace the previously best ask price in the queue for the given LTC offers. The user may enter a price that is the same or better than the displayed bid/ask price, which will cause the order to be executed at the displayed price. When multiple of the enterer prices are better, the system preferably executes the plurality of orders simultaneously. Alternatively, the trader may simply select or “take” the bidding or asking price to automatically execute the order for the selected order at the bid/ask price, as the case may be.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A system comprising a server computer coupled to a plurality of client devices over a communication network, the server computer configured at least to:
receive a plurality of orders for a service from the plurality of client devices, the plurality of orders comprising an order to purchase the service having a price and a size, and an order so sell the service having a price and a size, wherein the size of the purchase order and the sell order is stated in time units and wherein the price of the purchase order and the sell order is stated in time units;
maintain a dynamic trade book comprising the plurality of orders sorted based on best price;
match purchase orders and the sell orders;
automatically execute matching purchase orders and the sell orders; and
update account records to reflect executed purchase orders and the sell orders.

2. The system of claim 1, wherein the service comprises long term care services.

3. The system of claim 1, the server further configured to cause an interface screen to be displayed at client devices, the interface screen comprising form elements for users to enter purchase order and the sell order details.

4. The system of claim 1, the server further configured to cause an interface screen to be displayed at client devices, the interface screen comprising a representation of the trade book in a tabular form.

5. The system of claim 4, the server further configured to cause an interface screen to be displayed at client devices, the interface screen comprising a form element for a service provider to set aside hour units for exchange against purchase orders.

6. The system of claim 1, the server further configured to interface with a payroll management system and update account records to reflect service units earned for a predetermined period of time.

7. The system of claim 1, the server further configured to cause an interface screen to be displayed at client devices, the interface screen comprising form elements for users to enter purchase order and the sell order details, wherein the purchase order details comprises at least price, size, and duration of the order.

8. A method implemented in a system comprising a server computer coupled to a plurality of client devices over a communication network, the method comprising:
receiving, by the server computer, a plurality of orders for a service from the plurality of client devices, the plurality of orders comprising an order to purchase the service having a price and a size, and an order so sell the service having a price and a size, wherein the size of the purchase order and the sell order is stated in time units and wherein the price of the purchase order and the sell order is stated in time units;
maintaining, by the server computer, a dynamic trade book comprising the plurality of orders sorted based on best price;
matching, by the server computer, purchase orders and the sell orders;
automatically executing, by the server computer, matching purchase orders and the sell orders; and
updating, by the server computer, account records to reflect executed purchase orders and the sell orders.

9. The method of claim 8, wherein the service comprises long term care services.

10. The method of claim 8, comprising causing, by the server, an interface screen to be displayed at client devices, the interface screen comprising form elements for users to enter purchase order and the sell order details.

11. The method of claim 8, causing, by the server, an interface screen to be displayed at client devices, the interface screen comprising a representation of the trade book in a tabular form.

12. The method of claim 11, causing, by the server, an interface screen to be displayed at client devices, the interface screen comprising a form element for a service provider to set aside hour units for exchange against purchase orders.

13. The method of claim 8, interfacing, by the server, with a payroll management system and updating account records to reflect service units earned for a predetermined period of time.

14. The method of claim 8, causing, by the server, an interface screen to be displayed at client devices, the interface screen comprising form elements for users to enter purchase order and the sell order details, wherein the purchase order details comprises at least price, size, and duration of the order.

15. The method of claim 8, wherein the system is configured to display a plurality of interface screens based on access permissions from a plurality of access permissions comprising customer, provider, and trader access permissions, the plurality of interface screen comprising a customer interface screen, a provider interface screen, and a trader interface screen, wherein the plurality of interface screens include therein form elements accessible only by a given user based on the access permission.

16. The method of claim 15, wherein the customer interface screen comprises a listing of a plurality of available sell orders stated in time units, each of the sell orders including a bid price form element and an ask price form element, and wherein the customer interface screen allows the given user to enter a price in the bid price form element and not the ask price form element.

17. The method of claim 15, wherein the provider interface screen comprises a listing of a plurality of available buy orders stated in time units, each of the buy orders including a bid price form element and an ask price form element, and wherein the provider interface screen allows the given user to enter a price in the ask price form element and not the bid price form element.

18. The method of claim 15, wherein the trader interface screen comprises a listing of a plurality of available buy and sell orders stated in time units, each of the buy and sell orders including a bid price form element and an ask price form element, and wherein the trader interface screen allows the given user to enter a price in the bid price form element and the ask price form element.

19. The method of claim 18, wherein the trader interface screen allows the given user to enter price information in a plurality of the bid price form element and ask price form elements, and wherein the system automatically executes orders at a best price for each of the price information entered by the user that is better than the displayed prices.
